(19) United States
(12) Patent Application Publication
(10) Pub. No.: US 2024/0262341 A1
(43) Pub. Date: Aug. 8, 2024

(54) CONSTANT ENGINE TORQUE STRATEGY FOR AN IMPROVED CATALYST HEATING PHASE

(71) Applicant: FCA US LLC, Auburn Hills, MI (US)

(72) Inventors: Indrasen Karogal, Auburn Hills, MI (US); Nadirsh Patel, Farmington Hills, MI (US); Guarav Sadekar, Rochester Hills, MI (US); Dario Morina, Turin (IT); Alessandro Lelli, Turin (IT); Giuseppe Corallo, Turin (IT); Pier Luca Di Gristina, Turin (IT); Paolo Olivieri, Pecello Torinese (IT); Frederico de Bosio, Turin (IT)

(21) Appl. No.: 18/426,651

(22) Filed: Jan. 30, 2024

Related U.S. Application Data
(60) Provisional application No. 63/483,620, filed on Feb. 7, 2023.

(51) Int. Cl. B60W 20/16; F01N 3/10; F02D 41/02

(52) U.S. Cl. CPC B60W 20/16; F01N 3/101; F02D 41/0255; B60W 2540/10; B60W 2710/0666; F02D 2200/0802

(57) ABSTRACT

An emissions control technique for a mild hybrid electric vehicles (MHEV) includes determining a constant torque level to be generated by an engine for optimal heating of a catalyst to a light-off temperature, controlling the engine to maintain the constant torque level when an electric traction motor is capable of satisfying a driver torque request, wherein the electric traction motor is connected to a driveline of the MHEV and is temporarily disconnected from the engine, and when the electric traction motor is incapable of satisfying the driver torque request, controlling the engine to temporarily increase or decrease its torque output from the constant torque level to assist the electric traction motor in satisfying the driver torque request.

### CROSS-REFERENCE TO RELATED APPLICATION(S)

The present application claims the benefit of U.S. Provisional Application No. 63/483,620, filed on Feb. 7, 2023. The disclosure of this application is incorporated herein by reference in its entirety.

### FIELD

The present application generally relates to hybrid vehicles having an engine and at least one electric motor and, more particularly, to a constant engine torque strategy for an improved catalyst heating phase.

### BACKGROUND

Engine catalyst light-off is a process during which a vehicle exhaust system catalyst (e.g., a three-way catalytic converter) is heated up until its operating temperature reaches an acceptable range for efficient emissions reduction/control. One goal is to perform this procedure in a fast and optimized manner such that emissions are minimized or mitigated and normal vehicle operation (maximum performance) is quickly achievable. Conventional catalyst light-off techniques for hybrid vehicles are not optimized for catalyst temperature. More specifically, these conventional heating techniques typically select a particular operation mode (series vs. parallel, selected gear, etc.) to choose a constant engine speed and torque for the entire catalyst warm-up phase. Accordingly, while such conventional solutions do work well for their intended purpose, there exists an opportunity for improvement in the relevant art.

### SUMMARY

According to one example aspect of the invention, an emissions control system for a mild hybrid electric vehicle (MHEV) is presented. In one exemplary implementation, the emissions control system comprises a set of sensors configured to measure a set of operating parameters of a hybrid powertrain of the MHEV, the set of measured operating parameters including (i) a driver torque request indicative of a desired amount of drive torque to be generated by the hybrid powertrain and (ii) a temperature of a catalyst in an exhaust system of an engine of the hybrid powertrain and a control system configured to control a cold start procedure of the engine of the hybrid powertrain, the cold start procedure being completed when the catalyst temperature reaches a light-off temperature and including determining a constant torque level to be generated by the engine for optimal heating of the catalyst to the light-off temperature, controlling the engine to maintain the constant torque level when an electric traction motor of the hybrid powertrain is capable of satisfying the driver torque request, wherein the electric traction motor is connected to a driveline of the MHEV and is temporarily disconnected from the engine, and when the electric traction motor is incapable of satisfying the driver torque request, controlling the engine to temporarily increase or decrease its torque output from the constant torque level to assist the electric traction motor in satisfying the driver torque request.

In some implementations, the hybrid powertrain further includes an electric starter/generator motor of a belt-driven starter/generator (BSG) unit connected to a crankshaft of the engine, the electric starter/generator motor is powered by a 12 V battery system, and the electric traction motor is powered by a 48 Volt (V) battery system. In some implementations, the electric traction motor and its 48 V battery system are incapable of satisfying a plurality of different driver torque requests. In some implementations, the control system is configured to start the engine upon initiating the cold start procedure and then increase the torque output of the engine to the constant torque level. In some implementations, when the driver torque request exceeds a maximum torque capability of the electric traction motor, the control system is configured to increase the engine torque output above the constant torque level. In some implementations, when the driver torque request falls below a difference between the constant torque level and a minimum torque capability of electric traction motor, the control system is configured to decrease the engine torque output below the constant torque level.

In some implementations, the hybrid powertrain further comprises a transmission comprising a first sub-transmission associated with even gears and a second sub-transmission associated with odd gears, the first sub-transmission is connected between the driveline, the electric traction motor, and a first disconnect clutch, wherein the first disconnect clutch s configured to selectively connect the first sub-transmission and the electric traction motor to the engine, and the second sub-transmission is connected between the driveline and a second disconnect clutch, wherein the second disconnect clutch is configured to selectively connect the second sub-transmission to the engine. In some implementations, the catalyst is a three-way catalytic converter.

According to another example aspect of the invention, an emissions control method for an MHEV is presented. In one exemplary implementation, the emissions control method comprises obtaining, by a control system and from a set of sensors, a set of measured operating parameters of a hybrid powertrain of the MHEV, the set of measured operating parameters including (i) a driver torque request indicative of a desired amount of drive torque to be generated by the hybrid powertrain and (ii) a temperature of a catalyst in an exhaust system of an engine of the hybrid powertrain and controlling, by the control system, a cold start procedure of the engine of the hybrid powertrain, the cold start procedure being completed when the catalyst temperature reaches a light-off temperature and including determining a constant torque level to be generated by the engine for optimal heating of the catalyst to the light-off temperature, controlling the engine to maintain the constant torque level when an electric traction motor of the hybrid powertrain is capable of satisfying the driver torque request, wherein the electric traction motor is connected to a driveline of the MHEV and is temporarily disconnected from the engine, and when the electric traction motor is incapable of satisfying the driver torque request, controlling the engine to temporarily increase or decrease its torque output from the constant torque level to assist the electric traction motor in satisfying the driver torque request.

In some implementations, the hybrid powertrain further includes an electric starter/generator motor of a BSG unit connected to a crankshaft of the engine, the electric starter/generator motor is powered by a 12 V battery system, and the electric traction motor is powered by a 48 Volt (V) battery system. In some implementations, the electric traction motor and its 48 V battery system are incapable of satisfying a plurality of different driver torque requests. In some implementations, the method further comprises starting, by the control system, the engine upon initiating the cold start procedure and then increasing, by the control system, the torque output of the engine to the constant torque level. In some implementations, controlling the engine to temporarily increase or decrease its torque output includes increasing the engine torque output above the constant torque level when the driver torque request exceeds a maximum torque capability of the electric traction motor. In some implementations, controlling the engine to temporarily increase or decrease its torque output includes decreasing the engine torque output below the constant torque level when the driver torque request falls below a difference between the constant torque level and a minimum torque capability of electric traction motor.

In some implementations, the hybrid powertrain further comprises a transmission comprising a first sub-transmission associated with even gears and a second sub-transmission associated with odd gears, the first sub-transmission is connected between the driveline, the electric traction motor, and a first disconnect clutch, wherein the first disconnect clutch s configured to selectively connect the first sub-transmission and the electric traction motor to the engine, and the second sub-transmission is connected between the driveline and a second disconnect clutch, wherein the second disconnect clutch is configured to selectively connect the second sub-transmission to the engine. In some implementations, the catalyst is a three-way catalytic converter.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a mild hybrid vehicle (MHEV) having a low voltage hybrid powertrain and an example emissions control system according to the principles of the present application;

FIG. 2 is a flow diagram of an example emissions control method for an MHEV having a low voltage hybrid powertrain according to the principles of the present application; and

FIG. 3 is an example plot of torques versus time for an example cold start procedure of an MHEV having a low voltage hybrid powertrain according to the principles of the present application.

### DESCRIPTION

As previously discussed, conventional catalyst light-off or heating techniques for hybrid vehicles are not optimized for catalyst temperature. Specifically, these conventional solutions define an initial constant engine speed/torque in a particular mode as function of run time and thus the amount of engine torque is always the same at the beginning of the catalyst heating strategy regardless of the catalyst temperature. Therefore, while such conventional catalyst light-off or heating systems do work well for their intended purpose, there exists an opportunity for improvement in the relevant art.

Accordingly, improved catalyst heating systems and methods for mild hybrid vehicles (MHEVs) having low voltage hybrid powertrains, such as a belt-driven starter-generator (BSG) unit and a separate electric traction motor, are presented herein. The term “low voltage hybrid powertrain” refers to relatively lower voltage components (e.g., less than 100 volts (V), compared to high voltage powertrains having 400 V or 800 V components). Engine catalyst light-off is performed in a fast and optimized manner with the assistance from an electrified vehicle's supervisory controller, such as a hybrid control processor (HCP) or similar supervisory control module.

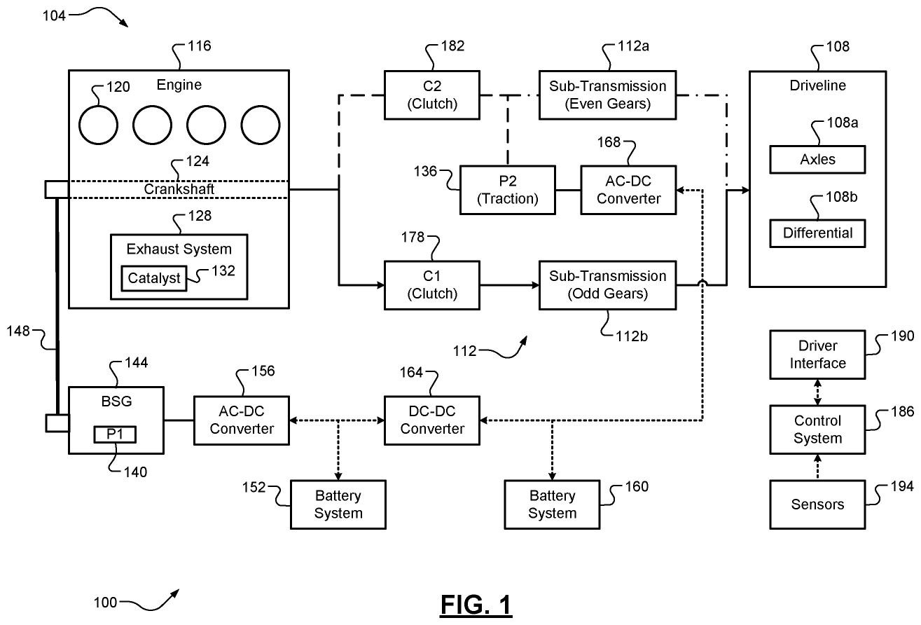

Referring now to FIG. 1, a functional block diagram of an MHEV 100 (also referred to as “vehicle 100”) having a low voltage hybrid powertrain and an emissions control system according to the principles of the present application is illustrated. The hybrid powertrain 104 is configured to generate and transfer torque to a driveline 108 via a transmission 112 (e.g., a multi-speed, step-gear automatic transmission) for vehicle propulsion. The hybrid powertrain 104 includes an internal combustion engine 116 that is configured to combust a mixture of air and fuel (gasoline, diesel, etc.) within cylinders 120 to generate torque at a crankshaft 124. Exhaust gas resulting from this combustion is expelled from the cylinders 120 and treated by an exhaust system 128 including a catalyst 132 (e.g., a three-way catalytic converter) to mitigate/eliminate emissions. In order to provide optimal emissions reduction, the catalyst 132 must reach a critical temperature, also known as a “light-off temperature.” The specific light-off temperature may vary based on the design of the catalyst 132 (e.g., amounts/types of precious metals loaded thereon).

The hybrid powertrain 104 also includes a first electric motor (P1) 140 (also referred to as “electric starter/generator motor 140”) that is part of a BSG system or unit 144, which is connected or coupled to the engine 116 (the crankshaft 124) via a belt or other suitable drive device. The BSG unit 144 (the electric starter/generator motor 140) is configured to drive the crankshaft 124 of the engine 116 using electrical energy provided by a first low voltage battery system (e.g., a 12 V battery system), such as to start the engine during stop/start operation and during cold start operations. The mechanical energy at the crankshaft 124 of the engine 116 is also able to drive the MGU unit 144 (the electric starter/generator motor 140) such that it generates electrical energy that is converted from AC to DC by the AC-DC converter 156 and can be used to recharged the battery system 152.

The hybrid powertrain 104 further includes a different second electric motor (P2) 136 (also referred to as “electric traction motor 136”) that is configured to generate drive torque that could potentially power the driveline 108 for vehicle propulsion. The electric traction motor 136 is powered by another low voltage battery system 160 (e.g., a 48 V battery system) that also has a DC-DC boost converter associated therewith 164. The transmission 112 is divided into two sub-transmissions 112a and 112b that are associated with even and odd gears of the transmission 112, respectively, which are both connected to the driveline 108 (i.e., more specifically, axles/half shafts 108a and/or a differential 108b). For example, the first sub-transmission 112a could be associated with even gears (2, 4, 6, 8, etc.) and the second sub-transmission 112b could be associated with odd gears (1, 3, 5, 7, etc.). A first disconnect clutch C1 178 selectively connects the engine 116 (the crankshaft 124) to the second sub-transmission 112b and a second disconnect clutch C2 182 selectively connects the engine 116 to the first sub-transmission 112a and the electric traction motor 140.

A control system 186 controls operation of the MHEV 100, including primarily controlling the hybrid powertrain 104 to generate specific amounts of torque. This could be, for example, to satisfy a driver torque request (T_{REQ}) provided by a driver of the MHEV 100 via a driver interface 190, such as an accelerator pedal. The control system 186 also uses a plurality of sensors 194 to measure a set of operating parameters of the MHEV 100 (the hybrid powertrain 104). The control system 186 could include, for example, a supervisory controller or HCP of the MHEV 100. It will be appreciated that the control system 186 could also include other sub-controllers or modules, such as an engine control module (ECM). In a series mode, with P1 140 charging the low voltage (12 V) bus and the DC-DC boost converter 164 charging the high voltage (48 V) bus, the 48 V of P2 136 cannot manage the required engine torque so the previously-described conventional functionality cannot be used. That is, the amount of engine torque is always the same at the beginning of the catalyst heating strategy regardless the catalyst temperature. Therefore, it will not be optimized according to the catalyst temperature.

Thus, proposed new strategy involves (1) the HCP commands a constant total torque (Ti) at first engine start and (2) the HCP maintains constant total torque Ti until the driver demand can be managed via the electric traction motor P2 136. Once that is not possible, the total torque Ti commanded from the HCP will change to keep P2 136 at its limits. Additionally, (3) the engine torque (Ti_{COLD}) will be a function of catalyst temperature. Thus, it will be able to adapt the amount of torque generated to the effective needs of the catalyst. Lastly, (4) the HCP disables an “X/N mode,” where X/N is the system state when clutch C2 182 is closed and the first sub-transmission 112a is open, so the engine 116 and the electric traction motor P2 136 are connected, to avoid any interruptions in engine torque while entering/exiting into/from X/N mode.

In summary, the HCP commands engine torque Ti considering the current system constraints (battery levels, P2 capacity, etc.), while also honoring the driver torque request. If the driver torque request overcomes the P2 capacity or capability, the HCP shall command the engine 116 to honor the driver torque request, temporarily, thereby at least temporarily leaving the constant Ti strategy. When these conditions are not satisfied, the HCP or another controller performs the catalyst heating strategy as in conventional solutions previously described herein.

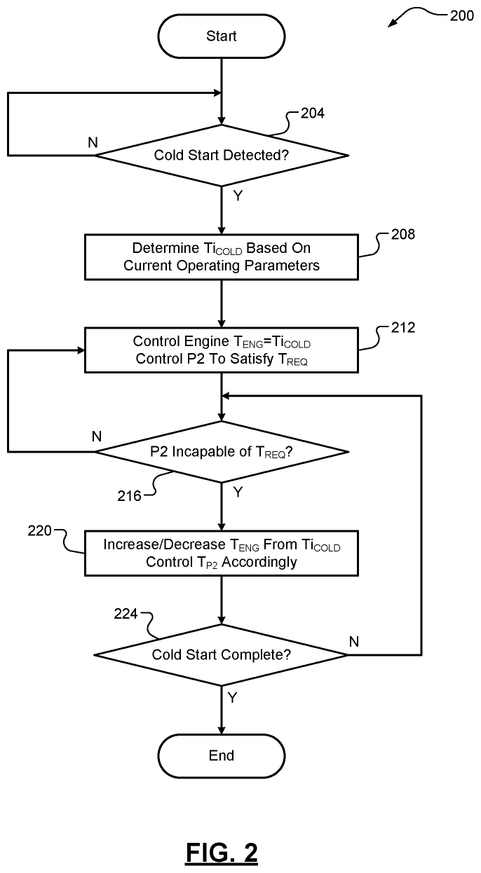

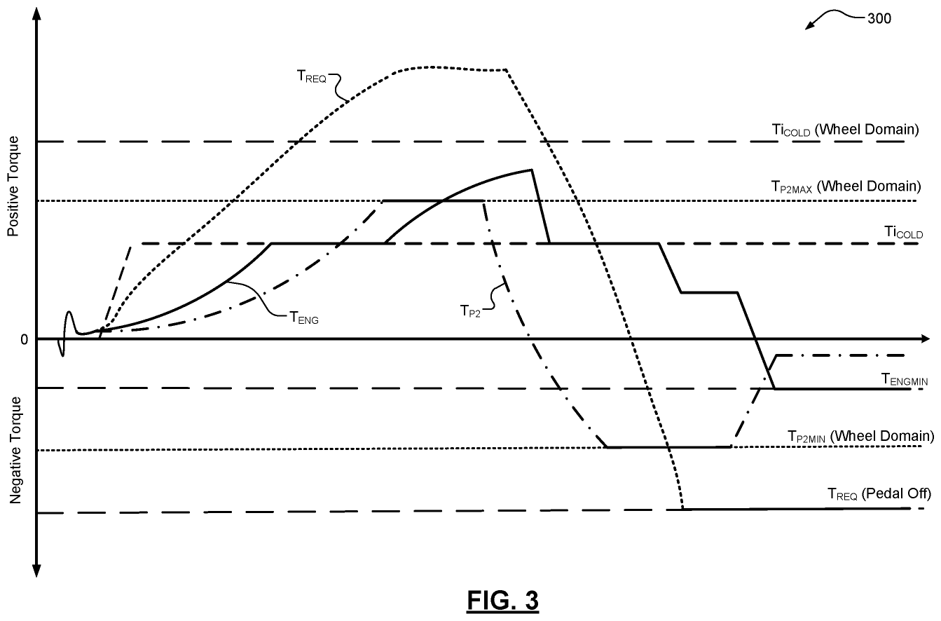

Referring now to FIGS. 2-3 and with continued reference to FIG. 1, a flow diagram of an example emissions control method 200 and a torque plot 300 during an example MHEV cold start procedure according to the principles of the present application re illustrated. While the MHEV 100 and its components are specifically referenced for illustrative/descriptive purposes, it will be appreciated that the method 200 could be applicable to any suitable configured MHEV having a low voltage hybrid powertrain. The method 200 begins at 204. At 204, the control system 186 determines whether a cold start of the engine 116 is detected. This could be, for example, in response to a key-on power-up request for the hybrid powertrain 104. FIG. 3 illustrates a BSG-assisted start of the engine 116 where the engine torque T_{ENG} initially fluctuates and then increases. At 208, the control system 186 determines the total cold start torque (Ti_{COLD}) based on the current operating parameters, e.g., measured by the sensors 194. This could include, for example, the driver torque request T_{REQ} and the current and target (light-off) temperatures of the catalyst 132.

At 212, the control system 186 controls the engine 116 to maintain a constant output torque at a level equal to the total cold start torque Ti_{COLD}. FIG. 3 illustrates the increase and holding of the engine torque T_{ENG} at this level Ti_{COLD}. The driver torque request T_{REQ}, however, may continue to increase, and could eventually exceed the maximum P2 torque (T_{P2MAX}) in the wheel domain as shown in FIG. 3. At 216, the control system 186 determines whether this occurs (i.e., whether P2 136 is incapable of satisfying the torque request T_{REQ} by itself). When false, the method 200 returns to 212. When true, however, the method 200 proceeds to 220. At 220, the control system 186 increases or decreases T_{ENG} from Ti_{COLD} and then controls T_{P2} accordingly. As shown in FIG. 3, T_{ENG} initially increases above Ti_{COLD}. In some cases, T_{ENG} could be commanded by the control system 186 to decrease below Ti_{COLD}. As shown in FIG. 3, for example, after the driver torque request T_{REQ} subsequently drops to a minimum (e.g., accelerator pedal-off). When P2 136 reaches its minimum torque (maximum negative torque) T_{P2MIN}, the engine torque T_{ENG}is commanded to decrease below Ti_{COLD}.

At 224, the control system 186 determines whether the cold start procedure has completed. This could occur, for example, when the temperature of the catalyst 132 reaches its light-off temperature. When false, the method 200 returns to 216 and the method 200 continues. After the cold start procedure has completed at 224, however, the method 200 ends and the hybrid powertrain 104 can resume normal operation/control.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An emissions control system for a mild hybrid electric vehicle (MHEV), the emissions control system comprising:
a set of sensors configured to measure a set of operating parameters of a hybrid powertrain of the MHEV, the set of measured operating parameters including (i) a driver torque request indicative of a desired amount of drive torque to be generated by the hybrid powertrain and (ii) a temperature of a catalyst in an exhaust system of an engine of the hybrid powertrain; and
a control system configured to control a cold start procedure of the engine of the hybrid powertrain, the cold start procedure being completed when the catalyst temperature reaches a light-off temperature and including:
determining a constant torque level to be generated by the engine for optimal heating of the catalyst to the light-off temperature;
controlling the engine to maintain the constant torque level when an electric traction motor of the hybrid powertrain is capable of satisfying the driver torque request, wherein the electric traction motor is connected to a driveline of the MHEV and is temporarily disconnected from the engine; and
when the electric traction motor is incapable of satisfying the driver torque request, controlling the engine to temporarily increase or decrease its torque output from the constant torque level to assist the electric traction motor in satisfying the driver torque request.

2. The emissions control system of claim 1, wherein:
the hybrid powertrain further includes an electric starter/generator motor of a belt-driven starter/generator (BSG) unit connected to a crankshaft of the engine;
the electric starter/generator motor is powered by a 12 V battery system; and
the electric traction motor is powered by a 48 Volt (V) battery system.

3. The emissions control system of claim 2, wherein the electric traction motor and its 48 V battery system are incapable of satisfying a plurality of different driver torque requests.

4. The emissions control system of claim 2, wherein the control system is configured to start the engine upon initiating the cold start procedure and then increase the torque output of the engine to the constant torque level.

5. The emissions control system of claim 4, wherein when the driver torque request exceeds a maximum torque capability of the electric traction motor, the control system is configured to increase the engine torque output above the constant torque level.

6. The emissions control system of claim 4, wherein when the driver torque request falls below a difference between the constant torque level and a minimum torque capability of electric traction motor, the control system is configured to decrease the engine torque output below the constant torque level.

7. The emissions control system of claim 1, wherein:
the hybrid powertrain further comprises a transmission comprising a first sub-transmission associated with even gears and a second sub-transmission associated with odd gears;
the first sub-transmission is connected between the driveline, the electric traction motor, and a first disconnect clutch, wherein the first disconnect clutch s configured to selectively connect the first sub-transmission and the electric traction motor to the engine; and
the second sub-transmission is connected between the driveline and a second disconnect clutch, wherein the second disconnect clutch is configured to selectively connect the second sub-transmission to the engine.

8. The emissions control system of claim 1, wherein the catalyst is a three-way catalytic converter.

9. An emissions control method for a mild hybrid electric vehicle (MHEV), the emissions control method comprising:
obtaining, by a control system and from a set of sensors, a set of measured operating parameters of a hybrid powertrain of the MHEV, the set of measured operating parameters including (i) a driver torque request indicative of a desired amount of drive torque to be generated by the hybrid powertrain and (ii) a temperature of a catalyst in an exhaust system of an engine of the hybrid powertrain; and
controlling, by the control system, a cold start procedure of the engine of the hybrid powertrain, the cold start procedure being completed when the catalyst temperature reaches a light-off temperature and including:
determining a constant torque level to be generated by the engine for optimal heating of the catalyst to the light-off temperature;
controlling the engine to maintain the constant torque level when an electric traction motor of the hybrid powertrain is capable of satisfying the driver torque request, wherein the electric traction motor is connected to a driveline of the MHEV and is temporarily disconnected from the engine; and
when the electric traction motor is incapable of satisfying the driver torque request, controlling the engine to temporarily increase or decrease its torque output from the constant torque level to assist the electric traction motor in satisfying the driver torque request.

10. The emissions control method of claim 9, wherein:
the hybrid powertrain further includes an electric starter/generator motor of a belt-driven starter/generator (BSG) unit connected to a crankshaft of the engine;
the electric starter/generator motor is powered by a 12 V battery system; and
the electric traction motor is powered by a 48 Volt (V) battery system.

11. The emissions control method of claim 10, wherein the electric traction motor and its 48 V battery system are incapable of satisfying a plurality of different driver torque requests.

12. The emissions control method of claim 10, further comprising starting, by the control system, the engine upon initiating the cold start procedure and then increasing, by the control system, the torque output of the engine to the constant torque level.

13. The emissions control method of claim 12, wherein controlling the engine to temporarily increase or decrease its torque output includes increasing the engine torque output above the constant torque level when the driver torque request exceeds a maximum torque capability of the electric traction motor.

14. The emissions control method of claim 13, wherein controlling the engine to temporarily increase or decrease its torque output includes decreasing the engine torque output below the constant torque level when the driver torque request falls below a difference between the constant torque level and a minimum torque capability of electric traction motor.

15. The emissions control method of claim 9, wherein:
the hybrid powertrain further comprises a transmission comprising a first sub-transmission associated with even gears and a second sub-transmission associated with odd gears;
the first sub-transmission is connected between the driveline, the electric traction motor, and a first disconnect clutch, wherein the first disconnect clutch s configured to selectively connect the first sub-transmission and the electric traction motor to the engine; and
the second sub-transmission is connected between the driveline and a second disconnect clutch, wherein the second disconnect clutch is configured to selectively connect the second sub-transmission to the engine.

16. The emissions control method of claim 9, wherein the catalyst is a three-way catalytic converter.
